(19) United States
(12) Patent Application Publication
(10) Pub. No.: US 2018/0352214 A1
(43) Pub. Date: Dec. 6, 2018

(54) Device for Securing a Travel Envelope

(71) Applicant: Volkswagen Aktiengesellschaft, Wolfsburg (DE)

(72) Inventor: Maciej Korzec, Berlin (DE)

(73) Assignee: Volkswagen Aktiengesellschaft, Wolfsburg (DE)

(21) Appl. No.: 15/994,174

(22) Filed: May 31, 2018

(30) Foreign Application Priority Data
Jun. 2, 2017 (DE) 10 2017 209 427.3

(51) Int. Cl. H04N 13/282; B60R 11/04; H04N 13/243

(52) U.S. Cl. CPC H04N 13/282; B60R 1/002; H04N 13/243; B60R 11/04

(57) ABSTRACT

The invention pertains to a device for monitoring the travel envelope of a vehicle, which comprises at least six cameras arranged on the vehicle for monitoring the environment and one calculating apparatus, wherein the cameras are formed by wide-angle cameras with an effective field of vision of at least 165° and are arranged to provide one or more stereoscopic fields of vision.

### CROSS-REFERENCE TO RELATED APPLICATIONS

This application claims priority to DE Application No. 10 2017 209 427.3 filed Jun. 2, 2017, the contents of which are hereby incorporated by reference in their entirety.

### BACKGROUND

The invention relates to a device for securing a travel envelope of a motor vehicle.

In modern automated driver assistance systems, a detailed understanding of the statistical and dynamic environmental scenario is increasingly required. The entire travel envelope must be secured for automated low-speed assistance, such as a park assist. In addition, obstacle detection is needed on the sides of the vehicle, such as for measuring parking spaces. Furthermore, curb detection is desirable for protecting the rims and for approaching curbs. The currently developed monocular systems have intrinsic disadvantages that, as system limits, cannot be overcome such as a minimum travel path, ego vehicles' movement requirement, precisions, problems with shade, mirroring, etc.

Initial stereo wide-angle systems including possibly object recognition by structure from motion have already been successfully tested, and a monocular system for recognizing the travel envelope of a vehicle is now being mass-produced. Front camera systems, which are frequently implemented with stereo cameras typically have a small angle and are not suitable for securing the travel envelope within the near range.

The document DE 10 2011 113 099 A1 relates to a method for determining objects in an environment of a vehicle. In the method, first environment information is determined that possesses position information of static objects in the environment, and second environment information that possesses position information of static and dynamic objects in the environment. Depending on the first environment information and second environment information, position information is identified from dynamic objects in the environment.

The document DE 10 2011 087 901 A1 relates to driver assistance systems that are designed to output representations of a vehicle environment to a driver, as well as a method in such a driver assistance system that comprises the following steps:
ascertain environment data with the assistance of an environment sensor system, wherein the environment sensor system comprises six cameras, respectively one front and one rear and respectively two on the sides of the vehicle;
determine a situation-dependent virtual camera perspective;
generate a representation of the environment, wherein the environment data are projected from the perspective of a virtual camera on an at least two-layer plane such as an object layer and a background layer; and
display the representation of the environment on a display device of the man/machine interface.

In so doing, the virtual camera perspective is determined as a function of objects in the vehicle environment and/or as a function of state variables of the vehicle, wherein the virtual camera can then be oriented toward at least one of the recognized objects, such as obstacles in the travel envelope.

The document U.S. Pat. No. 9,126,525 B2 discloses a warning device for the driver of a motor vehicle, wherein the environment of the motor vehicle is identified with an environmental sensor system. The environmental sensor system comprises four cameras, wherein in each case, one camera covers the front and rear environment, and one camera covers the left and right lateral environment of the vehicle.

The document U.S. Pat. No. 7,688,229 B2 describes a system for representing the environment of a motor vehicle on a vehicle display. Herein, video sequences of the environment of a motor vehicle are created by a spherical video camera system consisting of six MP cameras. The system is therefore capable of recording videos of more than 75% of the entire sphere.

The document DE 10 2013 200 427 A1 describes a method for generating a panoramic view image of a vehicle environment of a vehicle, wherein the panoramic view image is evaluated with regard to obstacle areas and freely drivable surfaces. The panoramic view image is generated from the images from four vehicle cameras that generate images of the front, rear and two lateral environments of the vehicle.

The document DE 10 2015 000 794 A1 relates to a panoramic view display device for displaying an environment of a motor vehicle using several camera apparatuses arranged at different positions on the vehicle, i.e., one camera on the right and one on the left side, and one front and one rear camera, and a display apparatus. The panoramic view display device is configured to display on the display device the environment of the vehicle in a synthesized bird's-eye view and in representations of the environmental areas of the vehicle identified by the camera apparatuses.

The previous systems are incapable of optimally securing the travel envelope of a vehicle, have problems in covering curb recognition, have mono-camera-related weaknesses, and/or are not real-time capable.

### SUMMARY

An object thus exists to improve securing the travel envelope, as well as the lateral area of a vehicle, in particular of a motor vehicle.

The object is solved by a device according to the invention. Preferred embodiments of the invention are described in the following description and the dependent claims.

In one aspect, a device for monitoring the travel envelope of a vehicle is provided, which comprises at least six cameras arranged on the vehicle for monitoring the environment and one calculating apparatus, wherein the cameras are formed by wide-angle cameras with an effective field of vision of at least 165°. Herein, two cameras are arranged on the front side of the vehicle at a given spacing such that the camera axis of the respective camera is angled to the outside at a respective given angle relative to the vehicle longitudinal axis, two cameras are arranged on the rear side of the vehicle at a given spacing such that the camera axis of the respective camera is angled to the outside at a respective given angle relative to the vehicle longitudinal axis, and just one camera is arranged on each side of the vehicle such that the camera axis of the respective camera is arranged parallel to the vehicle transverse axis. The two front-side cameras form a front-side stereoscopic field of vision, the two rear-side cameras form a rear-side stereoscopic field of vision, the left side camera with the front side left camera form a left side front stereo area, and the right side camera with the front side right camera form a right side front stereo area, the left side camera with the rear side left camera form a left side rear stereo area, and the right side camera with the rear side right camera form a right side rear stereo area. The left side camera forms a side left mono area, the right side camera forms a side right mono area, and the image data from the camera are compiled in the calculating apparatus such that at least eight fields of vision are formed.

### BRIEF DESCRIPTION OF THE DRAWINGS

In the following, the present invention will be explained in greater detail on the basis of various embodiments. In the FIGS., the same reference signs designate the same or similar elements.

In the drawings:

FIG. 1 shows a representation of the camera arrangement on the vehicle,

FIG. 2 shows a representation of the resulting stereo and mono areas,

FIG. 3 shows an identification of a dynamic object in the side area, and

FIG. 4 shows the device for securing the travel envelope in a schematic representation.

### DETAILED DESCRIPTION OF EMBODIMENTS

In some embodiments, at least part of the at least eight fields of vision are subjected to object recognition in an object recognition apparatus to recognize static and dynamic objects. The selection of the fields of vision whose compiled image data are subjected to object recognition is in principle a function of the installed computing capacity, i.e., all of the fields of vision can be investigated in real time given sufficient computing capacity.

In some embodiments and for the selection of the fields of vision, in which object recognition is carried out by the object recognition apparatus, to be a function of the speed from which the driving direction is deduced, and/or the steering angle of the vehicle. In other words, if the vehicle is driving forward, only the front side and side front fields of vision are subjected to object recognition. If however the driving direction is in reverse, the rear side and side rear fields of vision are subjected to object recognition, which yields a reduction of the required computing capacity. At higher speeds, the frame rate of images to be processed may have to be increased, which increases computational effort. In order to counteract this, the side cameras can be turned on and off as a function of the steering angle.

In some embodiments, the object recognition apparatus is configured to check whether recognized static or dynamic objects are located in the travel envelope of the vehicle. Accordingly, those recognized objects that are not located in the travel envelope can remain unconsidered.

In some embodiments, the device comprises an output apparatus that outputs recognized static or dynamic objects in the travel envelope to be represented on a display and/or on an assistance system. A park assist system may be an assistance system.

In some embodiments, the angles of the front side and rear side cameras lie within a range of 10° to 30° relative to the longitudinal vehicle axis. By selecting different angles, the fields of vision can be arranged asymmetrical to the longitudinal vehicle axis.

In some embodiments, the angles of the front side and rear side cameras are identical relative to the longitudinal vehicle axis. The same angles yield fields of vision that are arranged symmetrical to the longitudinal axis so that the required calculations are simplified.

In some embodiments, the angles of the front side and rear side cameras are each 15° to the outside relative to the longitudinal vehicle axis. This angle makes it possible to optimally recognize important parts of the travel envelope in stereo.

In some embodiments, it is provided to install a sufficient number of wide-angle cameras in the vehicle so that the entire environment, at least the travel envelope however, can be secured. A stereo system may be used in the travel envelope, wherein the installed positions are selected to be optimum, and the useful angle ranges of the cameras are taken into account. Because of their installed position, the side cameras can be effectively used to detect parking spaces and/or recognize curbs for which a monocular system is sufficient. Some embodiments describe a mono/stereo approach for completely detecting the environment, wherein in particular the entire travel envelope in the front and rear direction is detected as a stereo system.

Further embodiments of the invention are explained in greater detail below with reference to the drawings.

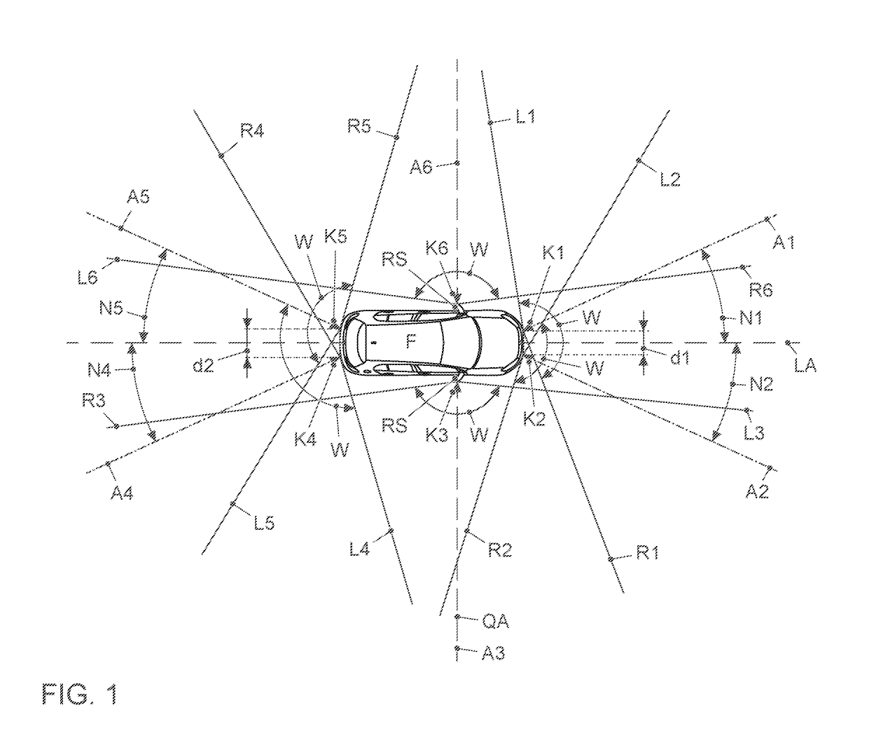

FIG. 1 shows an arrangement of the six cameras K1 to K6 on a motor vehicle F, wherein the cameras K1 to K6 that are used are wide-angle cameras with an effective viewing or opening angle W. The effective opening angle W in this example comprises a range of 160° to 170°, and is in particular 165° to 167.5°. The effective opening angle W of a wide-angle camera is understood to be the opening angle that can be reasonably used for calculating. If for example a wide-angle camera has an actual opening angle of 190°, normally only a range of 165° is used to evaluate image data since the distortion of the recorded image is so large in the outermost angle ranges that it would not make sense to evaluate this data from the edge range. In the embodiments described herein, the opening angle W of a wide-angle camera is therefore always understood to be the effective angle range explained above. The aforementioned angle ranges should not be understood as being restrictive; rather, they are only envisioned as an example. If wide-angle cameras with a large effective angle range are used, the possible stereo ranges correspondingly increase.

In the example of FIG. 1, the opening angles W are identical for all of the cameras K1 to K6 that are used which, however, is not essential. The vehicle's coordinate system has a longitudinal axis LA and a transverse axis QA perpendicular thereto, wherein the transverse axis QA in FIG. 1 is drawn at the height of the outside rearview mirror RS.

To monitor the front vehicle environment, two wide-angle cameras K1 and K2 are arranged with the aforementioned opening angle W at a spacing d1 on the front side of the vehicle F, wherein the camera K1 arranged on the left side has a camera axis A1, and the camera K2 arranged on the right side has a camera axis A2. The spacing d1 normally runs within a range of 0.4 to 1.5 m, in particular 0.6 m to 0.7 m depending on the arrangement of the cameras, wherein the arrangement depends on the front design of the vehicle, and the width of the vehicle is possible at most. The two cameras K1 and K2, i.e., their camera axes A1 and A2, are angled to the outside viewed from above by a given angle N1 and N2 relative to the longitudinal vehicle axis LA, wherein the horizontal angle N1 or respectively N2 lies within a range of 10° to 25°, and in particular 15°.

The vertical alignment, i.e., the pitch angle of the cameras, is not as important here as the addressed horizontal angle and angular widths. In standard vehicles, environmental cameras are typically angled downward slightly which allows wide-angle cameras to effectively cover the near range; the normal pitch angles of the cameras accordingly fit the concept presented here.

Normally, the two cameras K1 and K2 are angled to the outside by the same angle N1, N2, i.e., N1=N2; it is, however, also possible to choose two different horizontal angles N1, N2. Accordingly an angle N1 of 15° can be set on the driver's side, i.e., left side, for the camera K1, whereas the angle N2 of the right side camera K2 has a value of 25°; the useful stereo area formed from the two cameras K1 and K2 is therefore formed asymmetrically across the longitudinal axis LA and shifted to the right toward the driving direction.

The opening angle W of the two cameras K1 and K2 are defined by left and right opening angle limits or edges. Accordingly, the opening angle W of camera K1 is defined by the left edge L1 and by the right edge R1. Analogously, the edges L2 and R2 define the opening angle of camera K2, the edges L3 and R3 define the opening angle W of the camera K3, the edges L4 and R4 define the opening angle W of camera K4, the edges L5 and R5 define the opening angle W of the camera K5, and the edges L6 and R6 define the opening angle W of the camera K6. In this context, the terms “left” and “right” of the edges of the opening angles refer to the respective camera axis A1 to A6 of the cameras K1 to K6, and the term “opening angle” refers to the effective opening angle, i.e., image information from a camera outside of the opening angle is not considered.

In this example, the right side camera K3 is arranged at the location of the outside rearview mirror RS, wherein another side arrangement of the camera is also possible, for example in the side door, and its camera axis A3 coincides with the transverse axis QA of the vehicle F. In other words, the camera K3 is aligned perpendicular to the longitudinal vehicle axis LA, and the opening angle W is defined by the edges L3 and R3. An equivalent notation applies to the left side camera K6. In this case, the camera axis A6 coincides with the transverse axis QA of the vehicle F, and the opening angle W of the left side camera K6 is formed by the edges L6 and R6. If the two front cameras K1 and K2 are therefore arranged for example at an angle of 15° to the longitudinal vehicle axis LA, the angle between the side cameras K3 and K6 has a value of 75° relative to each adjacent front camera K1 and K2. In other words, the left side camera K6 is arranged offset to the left front camera by 75°, and the right side camera K3 also encloses an angle of 75° with the right front camera K2.

The two cameras K4 and K5 are arranged with a spacing d2 from each other on the rear of the motor vehicle F, wherein both rear cameras K4 and K5 are arranged angled to the outside by a respective angle N4 and N5 relative to the longitudinal vehicle axis LA. In this case as well, the horizontal angles N4, N5 lie within a range between 10° and 30°, wherein in the present case, equal angles are chosen for both cameras K4, K5, i.e., 15° to the outside relative to the longitudinal vehicle axis LA. Consequently, the angle between the left rear camera K5 and the left side camera K6 has a value of 75°, which also holds true for the combination of the right rear camera K4 and right side camera K3. The spacing d2 between the two rear cameras K4, K5 also lies within a range between 0.4 m and 1.5 m, in particular 0.6 m to 0.7 m, wherein d2 can assume the vehicle width at most.

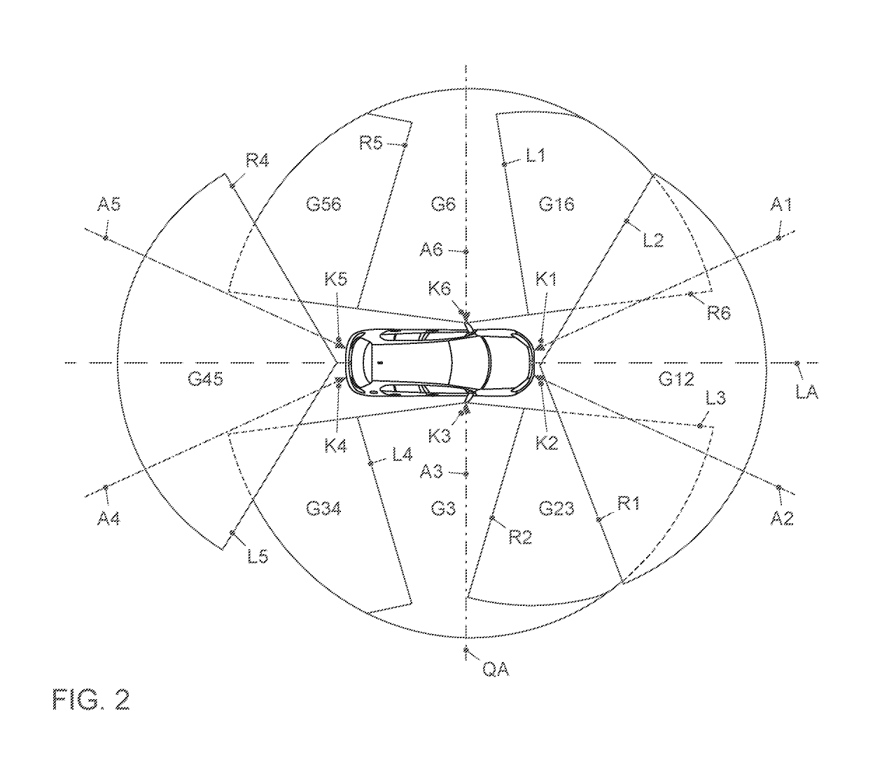

For reasons of improved representation, in FIGS. 1 and 2, the angles N1, N2, N4 and N5 of the front and rear cameras K1, K2, K4 and K5 are chosen as 25° relative to the longitudinal vehicle axis. In reality, i.e., the actual embodiment, an angle of 15° may be chosen.

FIG. 2 shows a schematic representation of the coverage of the environment of the vehicle F by the six cameras K1 to K6, wherein different areas arise from the interplay of the cameras. The overlapping of the opening angles W of the front cameras K1 and K2 yields a front field of vision G12 that is limited by the edges L2 of the left camera and R1 of the right camera. In this region G12, stereo recognition of obstacles and objects exists from the interaction of the two cameras K1 and K2.

With the right front camera K2 arranged at an angle N2, the side camera K3 arranged on the right side of the motor vehicle F forms a side stereo area G23 that is formed by the edges L3 and R2 and partially overlaps with the front stereo area G12.

The same holds true for the left side camera K6 that, with the left front camera K1 arranged at an angle N1, forms a left side stereo area G16 that has the edges R6 and L1 and partially overlaps with the front left stereo area G12.

The two side cameras K3 and K6 generate a respective mono field of vision G3 and G6 in the side direction, wherein the right side mono field of vision G3 is formed by the edges R2 and L4, and the left side mono area G6 is formed by the edges R5 and L1.

By means of the three front stereo areas G12, G23 and G16 and the three rear stereo areas G34, G45 and G56, a nearly complete stereo monitoring of the travel envelope of a motor vehicle is achieved with a range up to 10 m, e.g., 6.5 m so that sufficient travel envelope monitoring is provided, for example during a parking process. Curb recognition, parking space marking recognition or parking space measurement can occur using the two side mono areas G3 and G6.

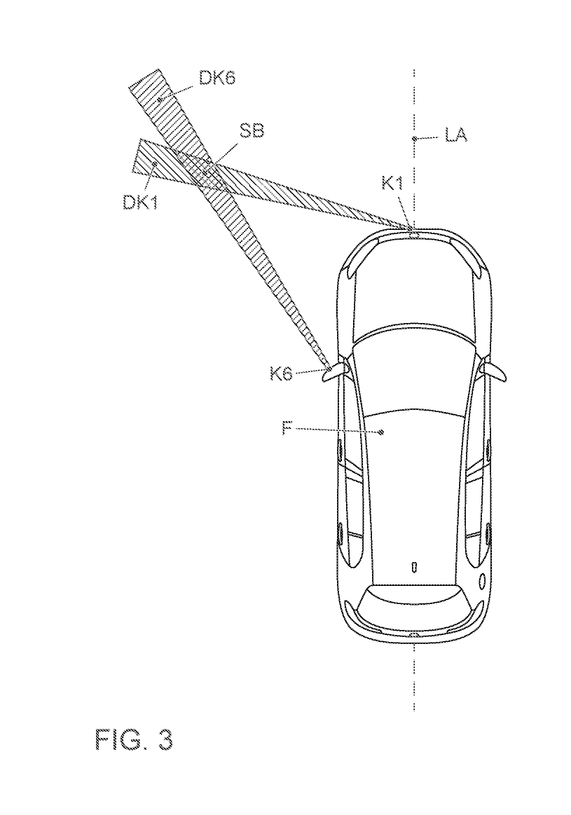

FIG. 3 shows for example the detection of moved objects in the side, front environment of vehicle F. If a moving object, for example a pedestrian, is detected by the two cameras K1 and K6 in the sectional area SB of the two detection lobes DK1 and DK6, a current estimated distance of the object can be calculated by triangulation. In the same manner, this naturally applies for all of the stereo areas generated by the combination of cameras K1 to K6.

By means of the above-described measures, the entire travel envelope of the vehicle can be detected by a stereo system, and rapid availability and improved precision is allowed. The coverages selected here moreover allow improved curb recognition in the critical areas G3 and G6 for rim protection. Given sufficient computing resources, the entire environment can therefore be detected, wherein a monocular system is sufficient for the vehicle sides. With modern processors, it is possible for four cameras K1, K2, K3 and K6 each to currently calculate in real time for forward travel, and for K3, K4, K5 and K6 to calculate for reverse travel. The sensor and hardware setting thereby approaches the requirements of customer functions in the low speed range, for example while parking. If a camera is soiled, there is not complete blindness; it can continue to work as a mono system.

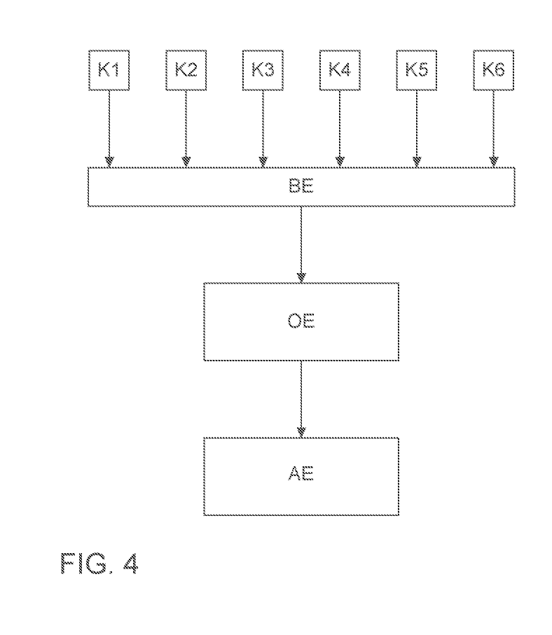

FIG. 4 shows a simplified schematic representation of a device for monitoring the travel envelope of a vehicle F with six cameras K1 to K6 with the arrangement on the vehicle F described in FIGS. 1 and 2, i.e., two front cameras K1 and K2, two rear cameras K4 and K5, and one side camera K3 and K6 on each side of the vehicle.

The signals from the cameras K1 to K6 are fed to a calculating apparatus BE that can be fed more vehicle signals (not shown) such as the current driving direction, driving speed and steering angle. In the calculating apparatus BE, these signals from the cameras K1 to K6 are combined so that the data of the different fields of vision G12 to G16 exist. In so doing, due to restricted computing capacity during forward driving, only the areas can be taken into account that are formed by the two front cameras K1 and K2 and the two side cameras K3 and K6, i.e., the fields of vision G12, G23, G3, G6 and G16. In reverse driving, only the fields of vision G3, G34, G45, G56 and G6 are analogously formed by the two rear cameras K4 and K5, as well as the two side cameras K3 and K6. Due to the steering angle, it is still possible to not consider the calculation of the side stereo area which is irrelevant for the travel envelope resulting from the steering angle.

In the following apparatus OE for identifying static and moving objects, static and moving objects are identified in the fields of vision formed by the camera signals, wherein the identification can be restricted to given fields of vision, for example only to those areas in forward travel that can be formed by the front cameras K1 and K2, and by the side cameras K3 and K6. Furthermore, spacings can be determined in the object identification apparatus OE by means of, for example, triangulation, and identified objects can be tracked by correspondingly saving object positions of previous measurements.

The results of the object identification apparatus OE are fed via an output apparatus to an assistant system such as a park assist, and/or represented on a display. The calculating apparatus BE, object identification apparatus OE and output apparatus AE can be a component of the central driver assist control unit.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The mere fact that certain measures are recited in mutually different dependent claims or embodiments does not indicate that a combination of these measured cannot be used to advantage. A computer program (code) may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

### REFERENCE SIGN LIST

F Vehicle
LA Longitudinal vehicle axis
QA Transverse vehicle axis
K1 Left front camera
K2 Left right camera
K3 Right side camera
K4 Right rear camera
K5 Left rear camera
K6 Left side camera
RS Outside rearview mirror
d1 Spacing between camera 1 and camera 2
d2 Spacing between camera 4 and camera 5
A1 Camera 1 axis
A2 Camera 2 axis
A3 Camera 3 axis
A4 Camera 4 axis
A5 Camera 5 axis
A6 Camera 6 axis
N1 Angle of camera 1 relative to the longitudinal vehicle axis
N2 Angle of camera 2 relative to the longitudinal vehicle axis
N4 Angle of camera 4 relative to the longitudinal vehicle axis
N5 Angle of camera 5 relative to the longitudinal vehicle axis
W Camera opening angle
L1 Camera 1 left opening angle limit
R1 Camera 1 right opening angle limit
L2 Camera 2 left opening angle limit
R2 Camera 2 right opening angle limit
L3 Camera 3 left opening angle limit
R3 Camera 3 right opening angle limit
L4 Camera 4 left opening angle limit
R4 Camera 4 right opening angle limit
L5 Camera 5 left opening angle limit
R5 Camera 5 right opening angle limit
L6 Camera 6 left opening angle limit
R6 Camera 6 right opening angle limit
G12 Stereo area of cameras K1 and K2
G23 Stereo area of cameras K2 and K3
G3 Mono area of camera 3
G34 Stereo area of cameras K3 and K4
G45 Stereo area of cameras K4 and K5
G56 Stereo area of cameras K5 and K6
G6 Mono area of camera K5
G16 Stereo area of cameras K1 and K6
DK1 Camera K1 detection lobe
DK6 Camera K6 detection lobe
SB Sectional area
BE Calculating apparatus
OE Object identifying apparatus
AE Output apparatus

What is claimed is:

1. A device for monitoring the travel envelope of a vehicle comprising at least six cameras arranged on the vehicle for monitoring the environment and one calculating apparatus, wherein the cameras are formed by wide-angle cameras with an effective field of vision of at least 165°, wherein
two cameras are arranged on the front side of the vehicle at a given spacing such that the camera axis of the respective camera is angled to the outside at a respective given angle relative to the vehicle longitudinal axis;
two cameras are arranged on the rear side of the vehicle at a given spacing such that the camera axis of the respective camera is angled to the outside at a respective given angle relative to the vehicle longitudinal axis;
just one camera is arranged on each side of the vehicle such that the camera axis of the respective camera is arranged parallel to the vehicle transverse axis;
the two front-side cameras form a front-side stereoscopic field of vision;
the two rear-side cameras form a rear-side stereoscopic field of vision;
the left side camera with the front side left camera form a left side front stereo area, and the right side camera with the front side right camera form a right side front stereo area;
the left side camera with the rear side left camera form a left side rear stereo area, and the right side camera with the rear side right camera form a right side rear stereo area;
the left side camera forms a side left mono area, and
the right side camera forms a side right mono area; and
the image data from the cameras are compiled in the calculating apparatus such that at least eight fields of vision are formed.

2. The device according to claim 1, wherein at least a part of the at least eight fields of vision are subjected to object recognition in an object recognition apparatus to recognize static and dynamic objects.

3. The device according to claim 2, wherein the fields of vision in which object recognition is carried out by the object recognition apparatus is a function of the speed and/or the steering angle of the vehicle.

4. The device according to claim 1, wherein the object recognition apparatus checks whether recognized static or dynamic objects are located in the travel envelope of the vehicle.

5. The device according to claim 4, wherein the device has an output apparatus that outputs the recognized static or dynamic objects in the travel envelope on a display and/or assistance system.

6. The device according to claim 1, wherein the angles of the front side and rear side cameras are within a range of 10° to 30° relative to the longitudinal vehicle axis.

7. The device according to claim 6, wherein the angles of the front side and rear side cameras are identical relative to the longitudinal vehicle axis.

8. The device according to claim 7, wherein the angles of the front side and rear side cameras are each 15° to the outside relative to the longitudinal vehicle axis.
